(19) United States
(12) Patent Application Publication
(10) Pub. No.: US 2025/0028578 A1
(43) Pub. Date: Jan. 23, 2025

(54) Predictive System for Dynamic Application Navigation

(71) Applicant: Bank of America Corporation, Charlotte, NC (US)

(72) Inventors: Janardhana Rao Chennamsetti, Fortmill, SC (US); Srinivas Dundigalla, Charlotte, NC (US); Sandeep Verma, Gurugram (IN); Nandini Rathaur, Mumbai (IN); Pavan Chayanam, Alamo, CA (US)

(21) Appl. No.: 18/223,618

(22) Filed: Jul. 19, 2023

(51) Int. Cl. G06F 9/54; G06F 9/451

(52) U.S. Cl. CPC G06F 9/542; G06F 9/451

(57) ABSTRACT

Arrangements for optimized navigation through an application are provided. In some examples, a request for application navigation assistance may be received from a user via an application executing on a device. The request for assistance may include identification of a desired destination within the application. A destination node associated with the identified destination may be identified and a current node of the may be identified. Based on the current node and the destination node, a machine learning model may be executed to output an optimized navigation route from the current node to the destination node. One or more user interfaces may then be dynamically generated and transmitted to the user to facilitate navigation through the application from the current node to the destination node.

### BACKGROUND

Aspects of the disclosure relate to electrical computers, systems, and devices for dynamically generating user interfaces to facilitate optimized navigation of a user within an application.

Conducting online transactions and using both web-based and mobile applications is part of every day life for most users. However, as applications become more complex and provide more robust features, it can be difficult for users to efficiently navigate to a desired screen, function or other destination within the application. This is particularly true when a user is on a screen other than a home screen and desires to navigate to a particular screen, function or other destination. Accordingly, it would be advantageous to determine, based on a current location of a user within an application, an optimized navigation route to navigate the user to a desired destination within the application and dynamically generate user interfaces to facilitate that navigation.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing optimized navigation through an application executing on a device.

In some examples, a request for assistance may be received from a user via an application executing on a device. The request for assistance may include identification of a desired destination, function, or the like, within the application to which the user would like to navigate. A computing platform may receive the request for assistance and identify a destination node associated with the identified destination. Further, the computing platform may identify a current node of the user (e.g., a screen from which the request for assistance was received). Based on the current node and the destination node, a machine learning model may be executed to output an optimized navigation route from the current node to the destination node. In some arrangements, computer resource availability data (e.g., available of one or more servers, application programming interfaces (APIs), or the like, associated with the application may be retrieved and used by the machine learning model to generate the optimized navigation route.

In some examples, the computing platform may generate and transmit, to a user computing device, a first user interface including a first selectable option representing a first or next node along the optimized navigation route. In some arrangements, the first selectable option may be available for selection and other options shown on the first user interface may be unavailable or may be shown having a modified appearance to indicate those options are not along the optimized navigation route. The computing platform may receive selection of the first selectable option from the user computing device and, in response, may generate a second user interface including a second selectable option along the optimized navigation route. In some examples, the second node may be the destination node.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing optimized application navigation in accordance with one or more aspects described herein;

FIGS. 2A-2H depict an illustrative event sequence for implementing optimized application navigation in accordance with one or more aspects described herein;

FIG. 3 depicts an illustrative method for implementing optimized application navigation in accordance with one or more aspects described herein;

FIGS. 4-8 illustrate graphical user interfaces that may be generated in accordance with one or more aspects described herein; and

FIG. 9 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, navigation through complex applications can be difficult for some users. Accordingly, aspects described herein provide optimized navigation route assistance to facilitate or guide a user through an application (e.g., through one or more screens of an application) to a desired destination.

In some aspects, customer log data may be parsed to identify nodes or screens within an application, a context of the node or screen, and an edge connecting a node to another node. The nodes, edges and context may be used to train a machine learning model to receive, as inputs, a current node of a user within the application and a destination node and output an optimized navigation route through the application. In some examples, current or real-time computer resource availability data may be received and used, by the machine learning model, to output an optimized navigation route through the application that avoids computer resources that are unavailable or are not operating at an optimal point.

Accordingly, a computing platform may receive a request for navigation assistance to a destination within an application from a user computing device. Based on the request for assistance, the computing platform may identify a current node or screen of the user (e.g., the node or screen from which the request for assistance was received) and a destination node corresponding to the desired destination. The computing platform may execute the machine learning model to output an optimized navigation route from the identified current node to the identified destination node.

In some arrangements, the computing platform may dynamically generate a first user interface including a selectable option associated with a first or next node along the optimized navigation route. The computing platform may receive user selection of the selectable option and, in response, may generate another user interface having another selectable option corresponding to a next node along the optimized navigation route. The computing platform may continue to generate user interfaces until the destination node within the application is reached by the user.

These and various other arrangements will be discussed more fully below.

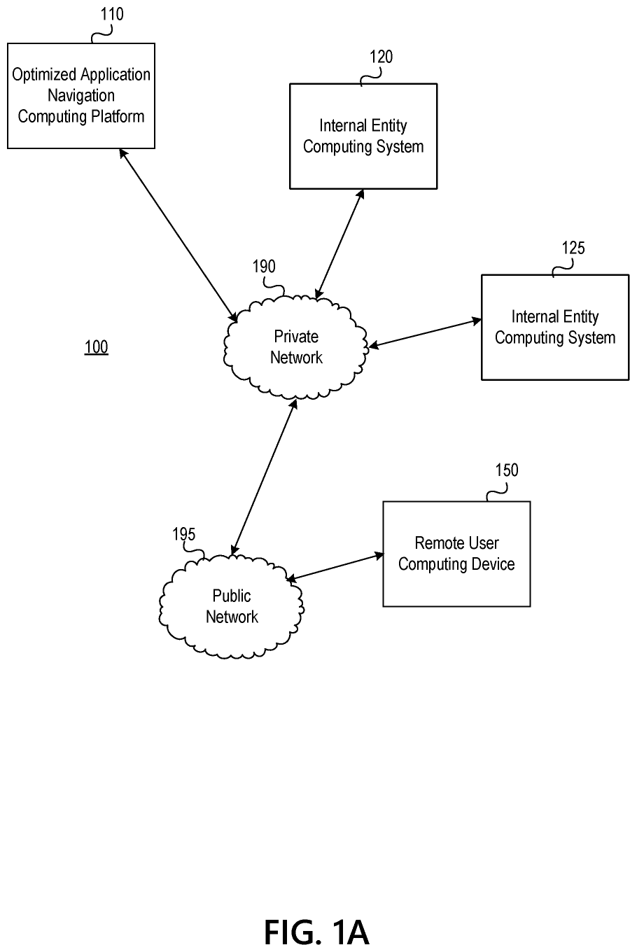

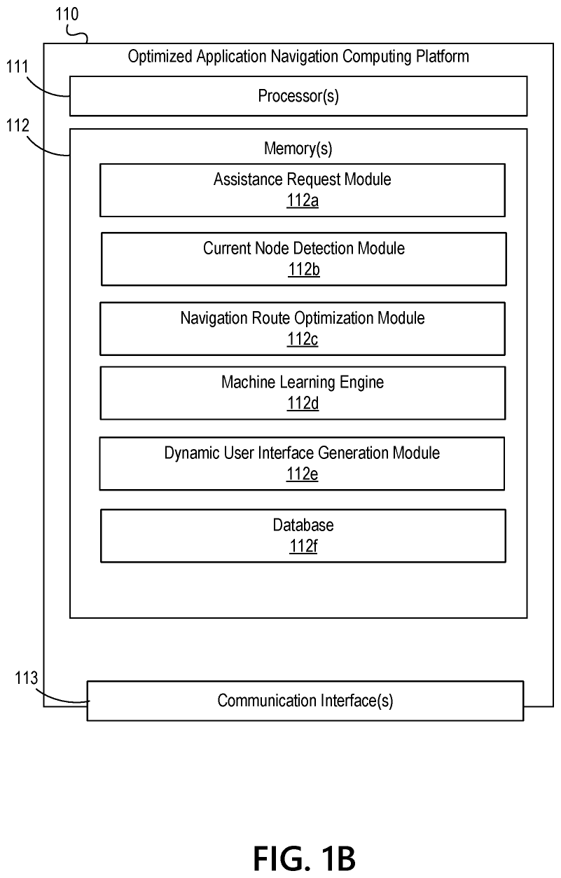

Accordingly, aspects described herein may be implemented using one or more computing devices operating in a computing environment. For instance, FIGS. 1A-1B depict an illustrative computing environment for implementing dynamic application navigation in accordance with one or more aspects described herein. Referring to FIG. 1A, computing environment 100 may include one or more computing devices and/or other computing systems.

For example, computing environment 100 may include optimized application navigation computing platform 110, internal entity computing system 120, internal entity computing system 125, and remote user computing device 150. Although two internal entity computing systems 120, 125 and one remote user computing device 150 are shown, any number of devices or systems may be used without departing from the invention.

Optimized application navigation computing platform 110 may be or include one or more computing devices (e.g., servers, server blades, or the like) and/or one or more computing components (e.g., memory, processor, and the like) and may be configured to provide dynamic, efficient optimized navigation within or through an application with which a user is interacting. For instance, optimized application navigation computing platform 110 may receive a request for assistance via a selectable option displayed on a first user interface. In some examples, the first user interface may be a screen of an application (e.g., web application, mobile application, or the like) executing on a user computing device, such as remote user computing device 150. In some examples, the request for assistance may include identification of a desired screen, function or destination within the application to which the user is requesting navigation assistance.

In response to receiving the request for assistance, optimized application navigation computing platform 110 may identify a current node of the user. For instance, optimized application navigation computing platform 110 may detect a current user interface or screen within the application of the user and identify that screen as a current node. Based on the identified current node, an optimized navigation route to the received destination may be computed. In some examples, computing the optimized navigation route may include executing a machine learning model to identify the optimized route. For instance, a machine learning model may be trained using customer application navigation logs to identify nodes within an application, as well as edges between nodes that indicate a path or connection between the nodes. In some arrangements, each node may include an additional property related to a context of the node (e.g., purpose of visit from the customer log). In some examples, computing resource availability data may also be used to train the machine learning model. For instance, the customer logs may indicate delays in navigation or processing based on back end issues (e.g., failed application programming interface (API) calls or the like). These issues may also be used to train the machine learning model to generate the optimized route.

In some examples, the current node and a node of the destination may be input to the machine learning model and the model may be executed to identify the optimized navigation route. In some arrangements, current computing resource availability data from one or more back end systems (e.g., internal entity computing system 120, internal entity computing system 125 or the like) may be received and used as inputs to the machine learning model. The model may then be executed to output the optimized navigation route.

Optimized application navigation computing platform 110 may then generate a first user interface and transmit the first user interface to the user device (e.g., remote user computing device 150) for display. The first user interface may include a first selectable option that may represent a first step in the optimized navigation route. In some examples, the first user interface may disable or modify an appearance of all other selectable options on the user interface such that only the first selectable option is available for selection by the user.

Optimized application navigation computing platform 110 may receive user selection of the first selectable option and, in response may generate a second user interface and transmit the second user interface to the user device for display. The second user interface may include a second selectable option representing a second step in the optimized navigation route. Similar to the first user interface, all other options on the second user interface may be disabled such that only the second selectable option is available to the user.

In some examples, the second user interface may include one or more additional fields or requests for user input to facilitate navigation to the destination. For instance, if a user desires to transfer funds, the first user interface may include the first selectable option for “transfers” and the second user interface may include the second selection option to continue to a next step and may also include a field or drop down menu requesting user input selecting an account from which the transfer should be made.

Optimized application navigation computing platform 110 may then continue to generate user interfaces guiding the user along the navigation route to the desired destination. In some examples, the optimized navigation route may include a shortest route (e.g., fewest nodes between the current node and a destination). Additionally or alternatively, the optimized navigation route may include a longer route (e.g. more nodes) but may navigate around computing resources that are not available or are not running optimally at that time (e.g., based on real-time computing resource availability data).

Internal entity computing system 120 and/or internal entity computing system 125 may be or include one or more computing devices (e.g., servers, server blades, or the like) and/or one or more computing components (e.g., memory, processor, and the like) and may host or execute one or more enterprise organization applications, systems, or the like. Accordingly, internal entity computing system 120 and/or internal entity computing system 125 may include computing resources that may provide data to populate user interfaces within an application, process transactions or events requested via the application, or the like. Accordingly, internal entity computing system 120 and/or internal entity computing system 125 may provide real-time availability data associated with one or more devices within the system, APIs supported by the systems 120, 125, or the like.

Remote user computing device 150 may be or include computing devices such as desktop computers, laptop computers, tablets, smartphones, wearable devices, and the like, that may be associated with a user (e.g., a customer of the enterprise organization). The remote user computing device 150 may be used to execute an application associated with the enterprise organization (e.g., mobile application, web-based application, or the like) and may enable user navigation within the application. Accordingly, remote user computing device 150 may receive (e.g., via user input) a request for navigation assistance within the application, may receive one or more dynamically generated user interface configured to facilitate navigation of the user from the current node to the destination node and display the user interfaces, may receive user input selecting options available via the user interface, and the like.

As mentioned above, computing environment 100 also may include one or more networks, which may interconnect one or more of optimized application navigation computing platform 110, internal entity computing system 120, internal entity computing system 125, and/or remote user computing device 150. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, optimized application navigation computing platform 110, internal entity computing system 120, and/or internal entity computing system 125, may be associated with an enterprise organization (e.g., a financial institution), and private network 190 may be associated with and/or operated by the organization, and may include one or more networks (e.g., LANs, WANs, virtual private networks (VPNs), or the like) that interconnect optimized application navigation computing platform 110, internal entity computing system 120, and/or internal entity computing system 125, and one or more other computing devices and/or computer systems that are used by, operated by, and/or otherwise associated with the organization. Public network 195 may connect private network 190 and/or one or more computing devices connected thereto (e.g., optimized application navigation computing platform 110, internal entity computing system 120, internal entity computing system 125) with one or more networks and/or computing devices that are not associated with the organization. For example, remote user computing device 150 might not be associated with an organization that operates private network 190 (e.g., because remote user computing device 150 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect remote user computing device 150 to private network 190 and/or one or more computing devices connected thereto (e.g., optimized application navigation computing platform 110, internal entity computing system 120, internal entity computing system 125).

Referring to FIG. 1B, optimized application navigation computing platform 110 may include one or more processors 111, memory 112, and communication interface 113. A data bus may interconnect processor(s) 111, memory 112, and communication interface 113.

Communication interface 113 may be a network interface configured to support communication between optimized application navigation computing platform 110 and one or more networks (e.g., network 190, network 195, or the like). Memory 112 may include one or more program modules having instructions that when executed by processor(s) 111 cause optimized application navigation computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of optimized application navigation computing platform 110 and/or by different computing devices that may form and/or otherwise make up optimized application navigation computing platform 110.

For example, memory 112 may have, store and/or include assistance request module 112a. Assistance request module 112a may store instructions and/or data that may cause or enable the optimized application navigation computing platform 110 to receive a request for assistance and analyze the request to identify a destination node. In some examples, the assistance request may include selection by a user of an option for assistance from a current screen or node of an application. The user may insert (e.g., using a touchscreen, keypad or other input device) a desired function or destination within the application. The user input may be analyzed to identify a destination node associated with the request. In some examples, the function or destination may be received via voice input from the user that may be analyzed using natural language processing to identify a destination node associated with the assistance request.

Optimized application navigation computing platform 110 may further have, store and/or include current node detection module 112b. Current node detection module 112b may store instructions and/or data that may cause or enable the optimized application navigation computing platform 110 to identify a current screen or node of a user requesting assistance. For instance, selection of an assistance request option may send, to the optimized application navigation computing platform 110, identification of a current screen or node of the user (e.g., the screen or node from which the request for assistance was selected). This current node may be used in the determination of the optimized navigation route.

Optimized application navigation computing platform 110 may further have, store and/or include navigation route optimization module 112c. Navigation route optimization module 112c may receive the identified destination node and identified current node and may determine (e.g., using machine learning engine 112d) an optimized navigation route within the application from the current node to the destination node. In some examples, navigation route optimization module 112c may receive current computing resource availability data (e.g., from one or more internal systems such as internal entity computing system 120, internal entity computing system 125, or the like). The computing resource availability data may include servers, APIs or the like that are unavailable or currently operating at less than optimal performance. The computing resource availability data may be real-time or near real-time data.

The navigation route optimization module 112c may work in conjunction with machine learning engine 112d to identify a current node and destination node and generate an optimized navigation route through the application from the current node to the destination node. For instance, machine learning engine 112d may store instructions and/or data that may cause or enable the optimized application navigation computing platform 110 to train, execute, validate and/or update one or more machine learning models that may be used to analyze current node data and destination node data to identify an optimized navigation route between the current node and the destination node. In some examples, the machine learning model may be trained (e.g., using data received from customer navigation logs) to identify various nodes or screens within the application and edges or paths connecting the nodes. For instance, customer application logs may capture entry and exit of each screen or node visited by a user, selections made, subsequent screens or nodes, and the like. Accordingly, the machine learning model may learn all nodes of an application and edges between each node. In some examples, training data may also be received from one or more developers or other administrators of the application who may identify one or more nodes, edges, or the like. In some examples, data associated with context of each node may be captured (e.g., from customer logs, developer input, or the like). The context data may include one or more functions available via a node, a subject matter of the node, or the like. Accordingly, a graph of nodes and corresponding edges may be generated. In some examples, the graph of nodes and edges may be specific to that application and/or format of the application (e.g., a web-based version of an application may have a different graph of nodes and edges than the mobile version of the same application).

The machine learning model may use, as inputs, the identified current node and destination node, as well as any available computer resource availability data, and may be executed to output an optimized navigation route from the current node to the destination node. In some examples, the optimized navigation route may include a route with a fewest number of intervening nodes (e.g., a shortest route from the current node to the destination node). In other examples, the optimized navigation route may be a route optimized to avoid computing resources that are unavailable or are not operating at an optimal capacity.

In some examples, a dynamic feedback loop may be used to provide, to the machine learning model, information related to execution of an optimized navigation route (e.g., selections made by a user, customer satisfaction information, and the like) to continuously update the model and improve accuracy of determined optimized navigation routes within an application.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data.

Upon the navigation route optimization module 112c generating the optimized navigation route based on output from the machine learning model executed by the machine learning engine 112d, one or more user interfaces may be dynamically generated to facilitate navigation of the user from the current node, through the application via the optimized navigation route, to the destination node. For instance, optimized application navigation computing platform 110 may have, store and/or include dynamic user interface generation module 112e. Dynamic user interface generation module 112e may store instructions and/or data that may cause or enable the optimized application navigation computing platform 110 to dynamically change or modify a user interface cascading style sheets (CSS) that defines the rendering of the user interface to generate a first user interface including a first selectable option associated with a first node in the navigation route. In some examples, the first user interface may include other options that are disabled to have a modified appearance to clearly identify the selectable option along the optimized navigation route (e.g., by changing or modifying the CSS).

Dynamic user interface generation module 112e may receive user selection of the first selectable option and may dynamically generate a second user interface including a second selectable option representing the next node along the optimized navigation route. Similar to the first user interface, the second user interface may include additional selectable options that are disabled or have a modified appearance to clearly identify the selectable option along the optimized navigation route. In some examples, the next node may be the destination node. Alternatively, the dynamic user interface generation module 112e may receive selection of the second selectable option and may generate subsequent user interfaces until the user reaches the destination node. In some examples, data may be gathered via each node along the optimized route (e.g., if the destination node is submission of a request to transfer funds, user interfaces to gather a sender account, a recipient account, and an amount may be traversed along the optimized navigation route and the collected data may be used to process the requested transfer).

Optimized application navigation computing platform 110 may further have, store and/or include database 112f. Database 112f may store data associated with customer logs, user requests for assistance, and/or other data that enables performance of the aspects described herein by the optimized application navigation computing platform 110.

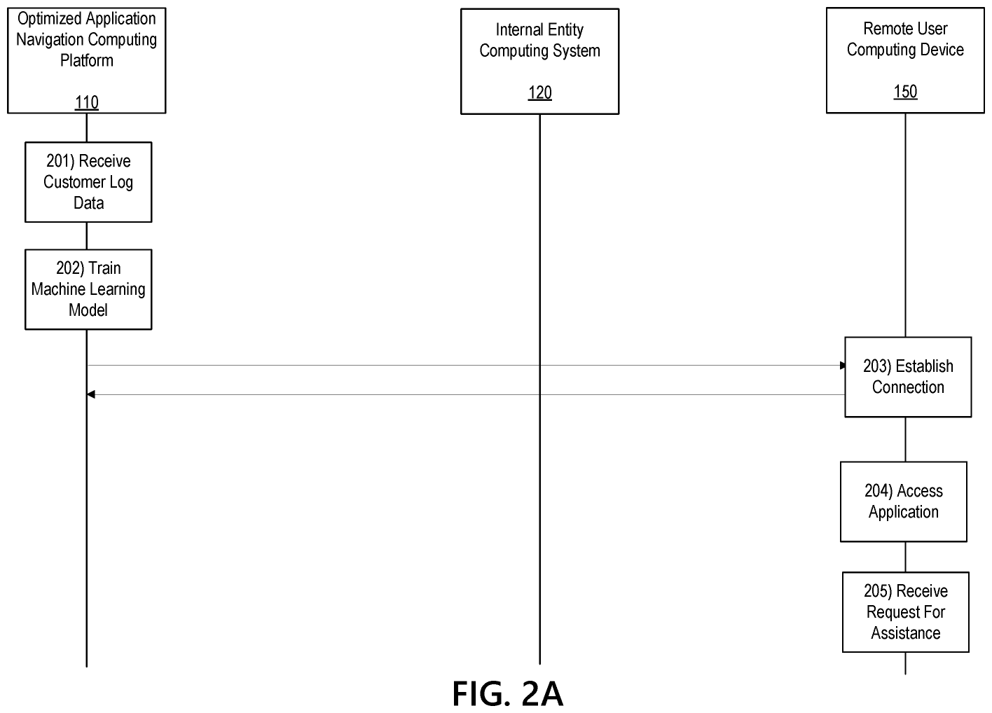

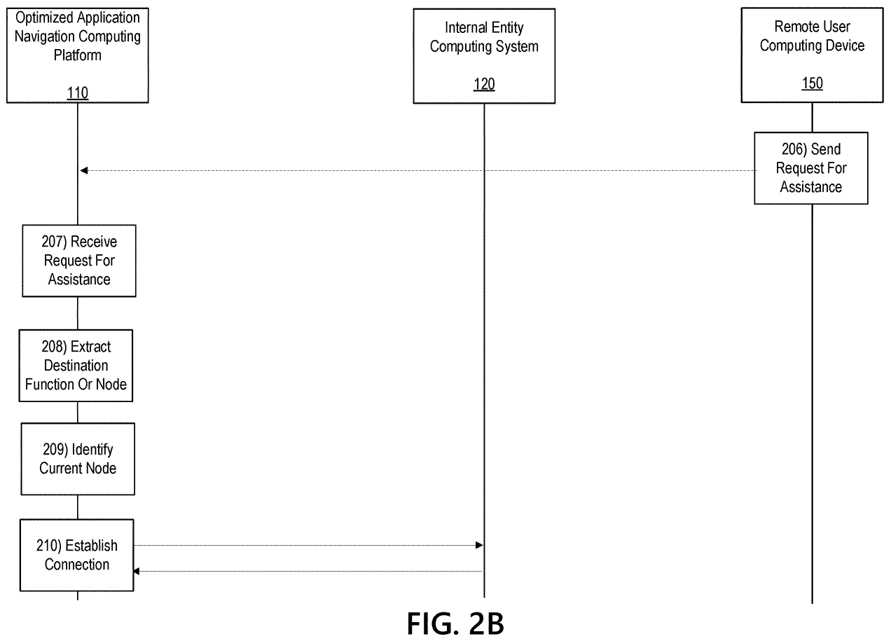

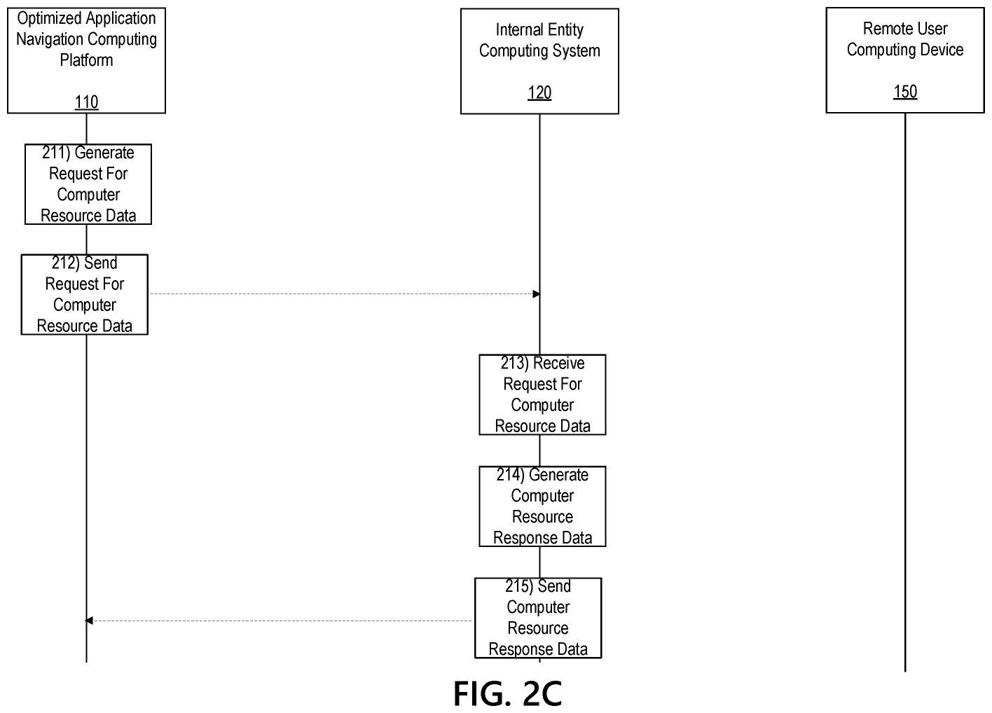

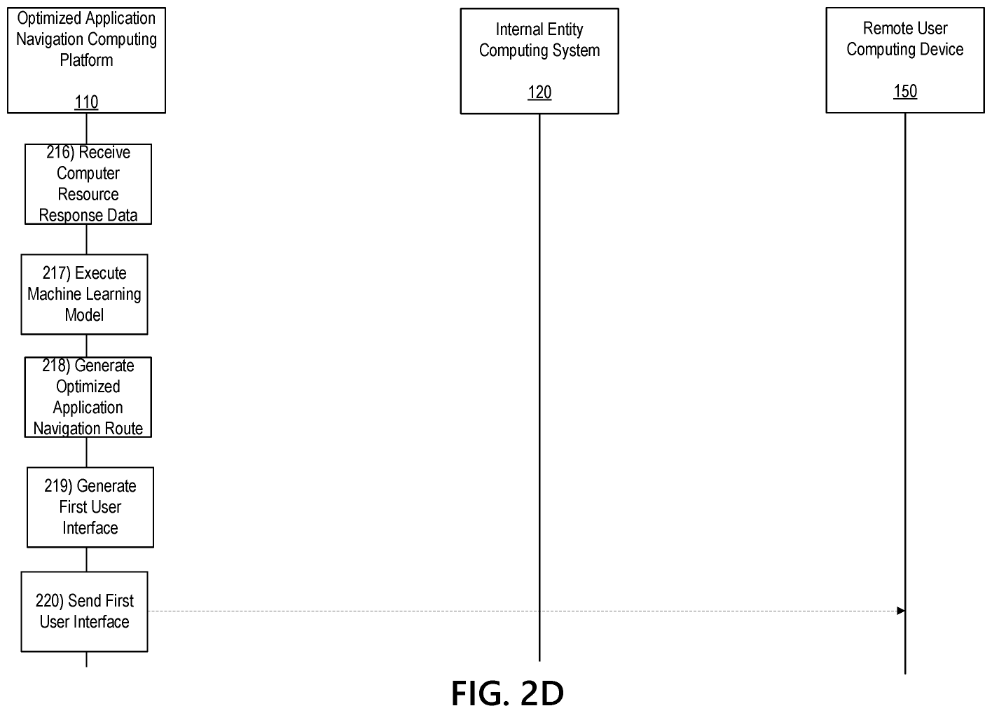

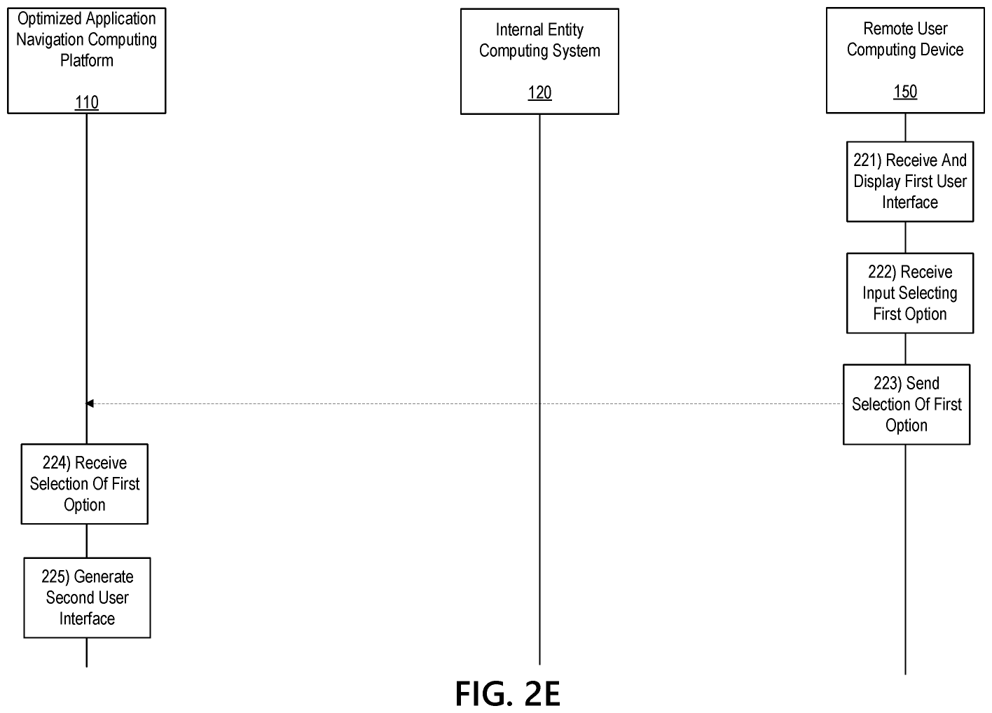

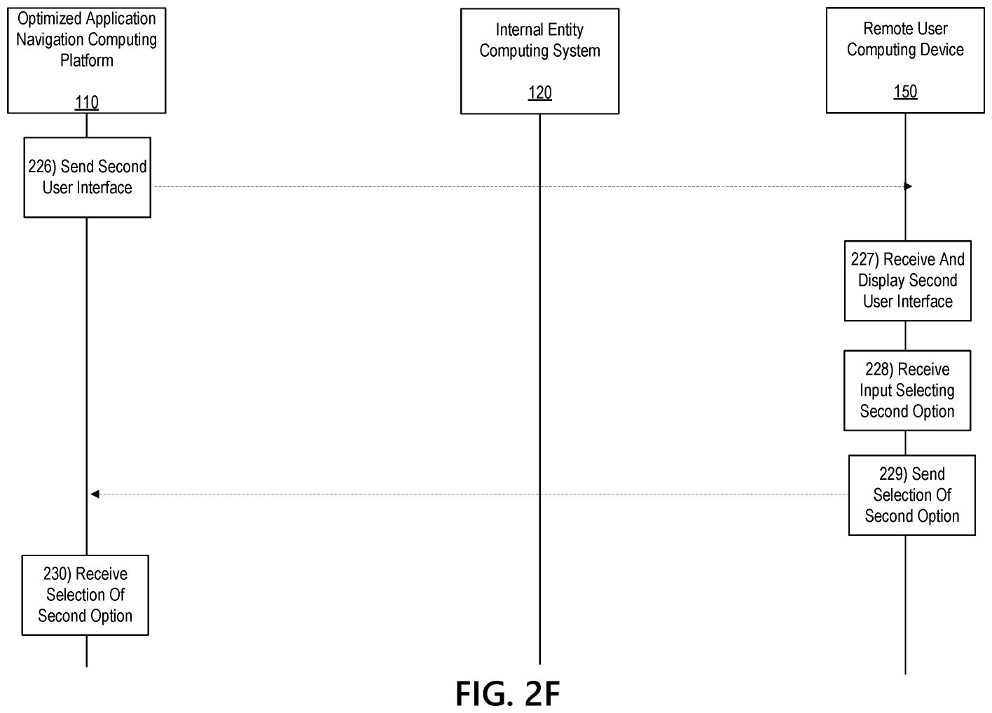

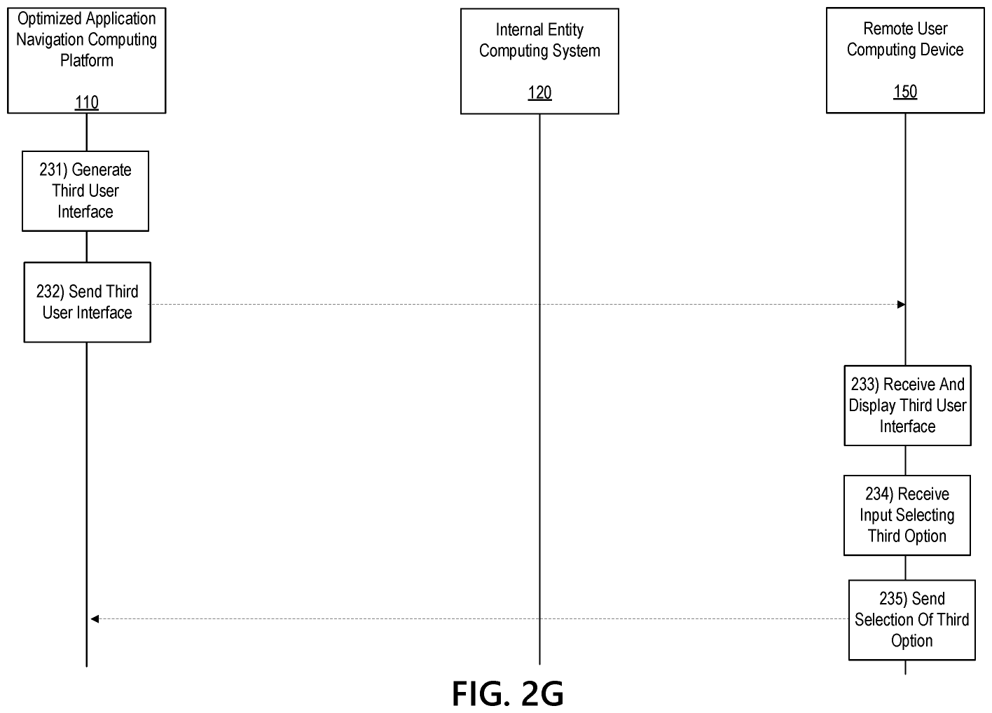

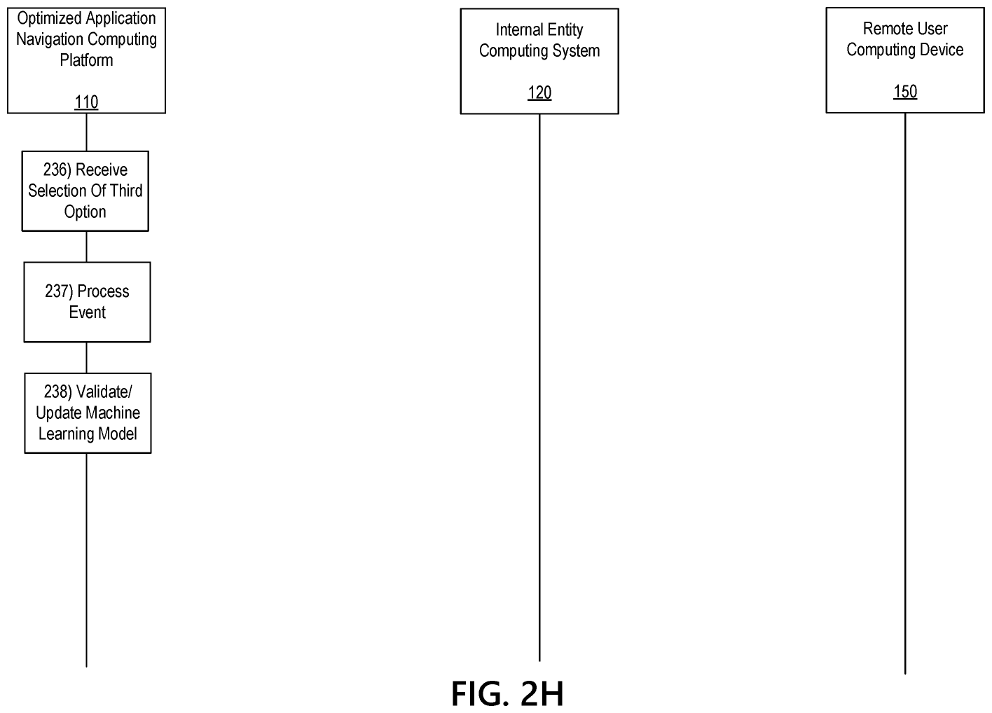

FIGS. 2A-2H depict one example illustrative event sequence for implementing optimized application navigation in accordance with one or more aspects described herein. The events shown in the illustrative event sequence are merely one example sequence and additional events may be added, or events may be omitted, without departing from the invention. Further, one or more processes discussed with respect to FIGS. 2A-2H may be performed in real-time or near real-time.

With reference to FIG. 2A, at step 201, optimized application navigation computing platform 110 may receive customer log data. For instance, optimized application navigation computing platform 110 may receive log data indicating historical navigation of customers or users within an application. In some examples, the customer log data may include selection of options, identification of nodes or screens visited by the user, edges or paths connecting two nodes or screens, and the like. The customer log data may be received from one or more internal computing devices or systems hosting or executing an application, such as internal entity computing system 120, internal entity computing system 125, or the like.

At step 202, optimized application navigation computing platform 110 may train a machine learning model. For instance, optimized application navigation computing platform 110 may train, using the customer log data, the machine learning model to generate one or more optimized navigation paths within the application. For instance, the machine learning model may be trained to receive, as inputs, a current node and a destination node and generate an optimized navigation path from the current node to the destination node. In some examples, the machine learning model may be further trained using data provided by one or more developers, administrators, or the like, including identification of nodes or edges, contextual data associated with nodes, or the like.

In some examples, the customer log data may include computer resources availability data (e.g., computer resources not available or running slowly, APIs unavailable, or the like). Accordingly, in some examples, the machine learning model may be trained to identify patterns or sequences to receive current computer resource availability data and generate the optimized application navigation route based on the current computer resource availability (e.g., as well as the current node and destination node).

At step 203, remote user computing device 150 may establish a connection with the optimized application navigation computing platform 110. For instance, a first wireless connection may be established between the remote user computing device 150 and the optimized application navigation computing platform 110. Upon establishing the first wireless connection, a communication session may be initiated between the remote user computing device 150 and the optimized application navigation computing platform 110.

At step 204, remote user computing device 150 may access an application. For instance, remote user computing device may access an application executing on the remote user computing device, such as a mobile application, or a web-based application.

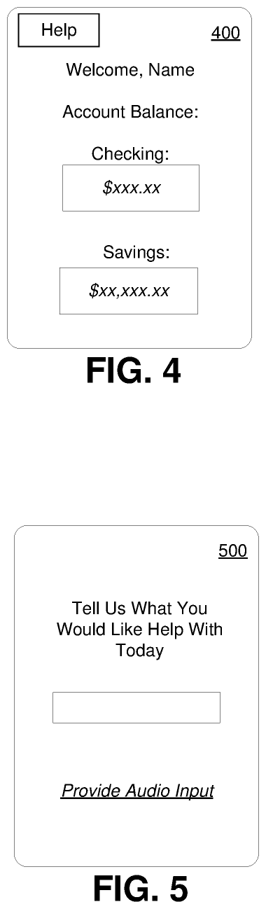

At step 205, the remote user computing device 150 may receive, via the application, a request for assistance. In some examples, the request for assistance may include selection of a “help” option displayed on a current node or screen of the application. For instance, FIG. 4 illustrates one example user interface 400 including a “help” option that may be accessed to request assistance.

In some examples, receiving the request for assistance may include identification of a particular function the user is attempting to access or may otherwise identify a destination associated with the user request. In some examples, the identified destination may be received via user input (e.g., via a touchscreen, keypad, or the like). In some examples, the identified destination may be received via voice input from the user (e.g., via a microphone of the remote user computing device 150) and natural language processing may be used to identify the destination from the voice input. For instance, FIG. 5 includes an interface 500 that may be provided to the user requesting additional details related to the request for assistance (e.g., in response to selection of “help” option from interface 400 in FIG. 4). The user may input a topic, destination, function or the like, into the field available for input, or may select “provide audio input” option to provide voice data identifying a destination or desired function.

With reference to FIG. 2B, at step 206, remote user computing device 150 may transmit or send the request for assistance to the optimized application navigation computing platform 110. For instance, the remote user computing device 150 may transmit or send the request for assistance during the communication session initiated upon establishing the first wireless connection.

At step 207, optimized application navigation computing platform 110 may receive the request for assistance and process the request. For instance, at step 208, a destination function or node may be extracted from the request for assistance. For example, based on a destination identified by the user, a destination screen or node may be identified.

At step 209, a current node of the user may be identified. For instance, based on the request for assistance, a current node or screen of the user within the application may be identified. In some examples, the current node or screen may be identified as the node or screen from which the request for assistance was received (e.g., an indication of selection of the request for assistance option from a particular screen).

At step 210, optimized application navigation computing platform 110 may connect to the internal entity computing system 120. For instance, a second wireless connection may be established between the optimized application navigation computing platform 110 and the internal entity computing system 120. Upon establishing the second wireless connection, a communication session may be initiated between the optimized application navigation computing platform 110 and the internal entity computing system 120.

With reference to FIG. 2C, at step 211, optimized application navigation computing platform 110 may generate a request for computer resource availability data. For instance, optimized application navigation computing platform 110 may generate a request for real-time or near real-time availability of computer resources (e.g., servers, APIs, or the like) associated with the application.

At step 212, optimized application navigation computing platform 110 may transmit or send the request for computer resource availability data to the internal entity computing system 120. For instance, the optimized application navigation computing platform 110 may transmit or send the request during the communication session initiated upon establishing the second wireless connection.

Although the arrangements show a request for computer resource availability data going to one internal entity computing system 120, in some examples, request for computer resource availability data may be transmitted or sent to multiple internal entity computing devices or systems (e.g., internal entity computing system 125, or the like) without departing from the invention.

At step 213, internal entity computing system 120 may receive the request for computer resource availability data. At step 214, the request may be executed and computer resource availability response data may be generated. In some examples, computer resource availability response data may include identification of current or real-time performance or availability of servers, APIs, or the like, associated with the application.

At step 215, internal entity computing system 120 may transmit or send the computer resource availability response data to the optimized application navigation computing platform 110.

With reference to FIG. 2D, at step 216, optimized application navigation computing platform 110 may receive the computer resource availability response data.

At step 217, optimized application navigation computing platform 110 may execute the machine learning model. For instance, optimized application navigation computing platform 110 may input, to the machine learning model, the current node, destination node, and/or computing resource availability response data. The machine learning model may be executed to output or generate an optimized application navigation route from the current node to the destination node at step 218. In some examples, the optimized application navigation route may include a shortest route between the current node and the destination node (e.g., fewest intervening nodes). Additionally or alternatively, the optimized application navigation route may include a shortest route between the current node and the destination node that avoids any computing resources that are unavailable or not performing at an optimal level.

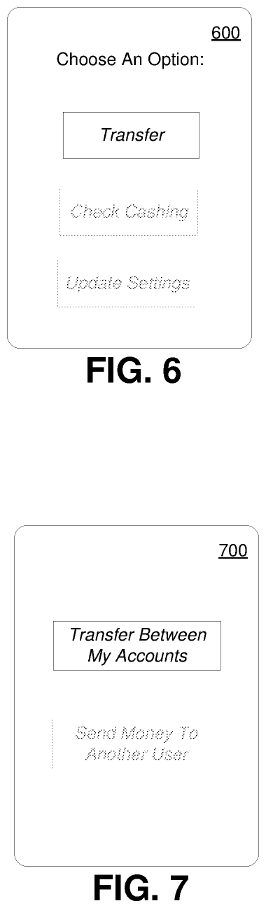

At step 219, based on the generated optimized application navigation route, a first user interface may be dynamically generated. For instance, a first user interface including a first selectable option associated with a next step along the optimized navigation route may be generated. In some examples, the first user interface may include the first selectable option and other selectable options may be disabled or have a modified appearance to indicate they are not on the optimized application navigation route. FIG. 6 illustrates one example first user interface 600 including the first selectable option with other options shown as unavailable (e.g., having a modified appearance). For example, a user request for assistance may have included an indication that the user would like to transfer funds between their accounts. Accordingly, interface 600 may be generated as a first user interface and may include a first selectable option (e.g., “transfer”) and other options may have a modified appearance or may be unavailable for selection or disabled.

At step 220, optimized application navigation computing platform 110 may transmit or send the first user interface to the remote user computing device 150. In some examples, transmitting or sending the first user interface to the remote user computing device 150 may cause the remote user computing device to display the first user interface on a display of the remote user computing device 150.

With reference to FIG. 2E, at step 221, remote user computing device 150 may receive and display the first user interface including the first selectable option. At step 222, remote user computing device 150 may receive user input selecting the first selectable option. At step 223, selection of the first selectable option by the user may be transmitted or sent by the remote user computing device 150 to the optimized application navigation computing platform 110.

At step 224, optimized application navigation computing platform 110 may receive and process the selection of the first selectable option. For instance, in response to receiving the selection of the first selectable option (e.g., next step along the optimized navigation route), optimized application navigation computing platform 110 may generate a second user interface including a second selectable option representing a next node along the optimized navigation route at step 225. FIG. 7 illustrates one example second user interface 700 including a second selectable option. Similar to the first user interface shown in FIG. 6, the second user interface 700 includes the second selectable option shown as available and other options shown as unavailable for selection. Accordingly, in continuing the example from above, in response to user selection of the first selectable option (e.g., “transfer”) in FIG. 6, interface 700 may be generated and may include a second selectable option (e.g., “transfer between my accounts”) representing the next node along the optimized navigation route. Other options may be unavailable or have a modified appearance as shown.

With reference to FIG. 2F, at step 226, optimized application navigation computing platform 110 may transmit or send the second user interface to the remote user computing device 150. In some examples, transmitting or sending the second user interface to the remote user computing device 150 may cause the remote user computing device to display the second user interface on a display of the remote user computing device 150.

At step 227, remote user computing device 150 may receive and display the second user interface including the second selectable option. At step 228, remote user computing device 150 may receive user input selecting the second selectable option. At step 229, selection of the second selectable option by the user may be transmitted or sent by the remote user computing device 150 to the optimized application navigation computing platform 110.

At step 230, optimized application navigation computing platform 110 may receive and process the selection of the second selectable option. For instance, in response to receiving the selection of the second selectable option (e.g., next step or node along the optimized navigation route), optimized application navigation computing platform 110 may generate a third user interface including a third selectable option representing a next node along the optimized navigation route.

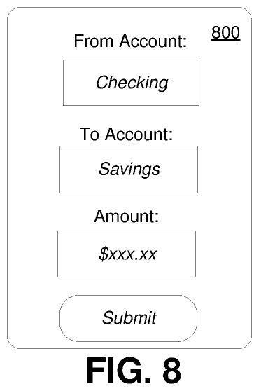

With reference to FIG. 2G, at step 231, optimized application navigation computing platform 110 may generate a third user interface. In some examples, the third user interface may include a third selectable option that may represent the destination node or a request for a user to authorize or finalize a requested event (e.g., indicating that the event should be processed). The third user interface may include an indication that options other than the third selectable option are unavailable. For instance, FIG. 8 includes one example third user interface 800 including a third selectable option representing the destination node. In continuing the example from above, third interface 800 may include additional fields in which the user may provide input (e.g., from account, to account, amount, or the like) and then “submit” option may be provided for selection in order to process the event.

At step 232, optimized application navigation computing platform 110 may transmit or send the third user interface to the remote user computing device 150. In some examples, transmitting or sending the third user interface to the remote user computing device 150 may cause the remote user computing device to display the third user interface on a display of the remote user computing device 150.

At step 233, remote user computing device 150 may receive and display the third user interface including the third selectable option. At step 234, remote user computing device 150 may receive user input selecting the third selectable option. At step 235, selection of the third selectable option by the user may be transmitted or sent by the remote user computing device 150 to the optimized application navigation computing platform 110.

With reference to FIG. 2H, at step 236, optimized application navigation computing platform 110 may receive and process selection of the third selectable option. In some examples, the third selectable option may represent a destination node or confirmation by the user to process a requested event (e.g., from the destination node). Accordingly, at step 237, optimized application navigation computing platform 110 may process the requested event. In some examples, processing the event may include transmitting an instruction or command to one or more internal computing devices or systems, such as internal entity computing system 120, internal entity computing system 125, or the like, to process the event.

At step 238, optimized application navigation computing platform 110 may update or validate the machine learning model based on the received user selections of one or more selectable options, processing the event, or the like. Accordingly, the machine learning model may be continuously updated and/or validate to improve accuracy of the model, optimize output of the model, or the like.

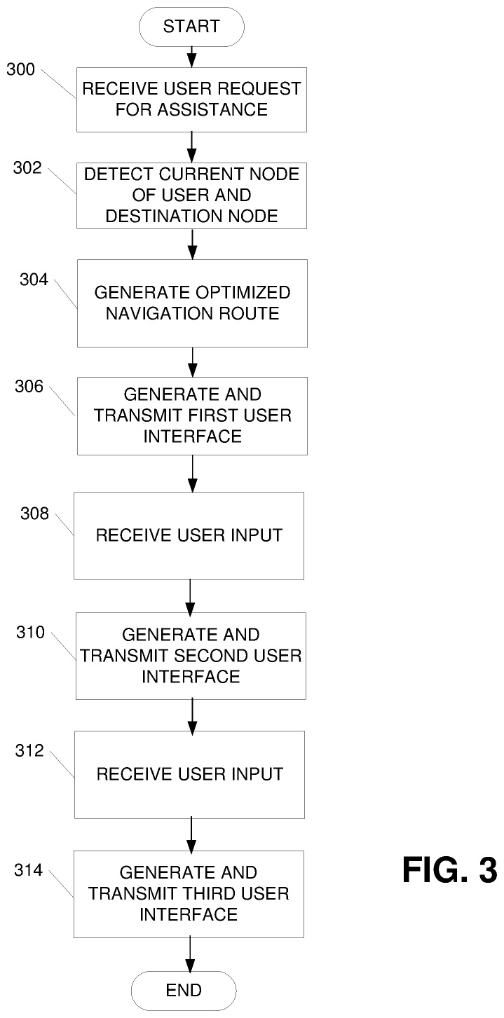

FIG. 3 is a flow chart illustrating one example method of optimized application navigation in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive, from a user device, a request for navigation assistance within an application. In some examples, the request for navigation assistance may include selection of a “help” option displayed on a current user interface displayed by the application. In some examples, the request for navigation assistance may include user input (e.g., text input, voice input, or the like) identifying a desired function, screen or other destination for the navigation.

At step 302, the computing platform may identify a current node of the user and a destination node associated with the identified destination or function. For instance, a current screen within the application may be identified as a current node of the user and a node associated with an identified destination or function may be identified as the destination node.

At step 304, a machine learning model may be executed to identify an optimized navigation route within the application from the current node to the destination node. For instance, the current node and destination node may be input to the machine learning model and, upon execution of the model, an optimized navigation route from the current node to the destination node may be output. In some examples, available computer resource data may be requested and received from one or more computing systems and the available computer resource data may also be used as inputs to the machine learning model to generate the optimized navigation route.

In some examples, the optimized navigation route may include a shortest distance (e.g., fewest intervening nodes) between the current node and the destination node. In other examples, the optimized navigation route may include a longer route (e.g., more intervening nodes) but may avoid computing resources that are unavailable or not operating at an optimal level.

At step 306, the computing platform may generate a first user interface including a first selectable option (e.g., corresponding to a first or next node along the optimized navigation route) to facilitate navigation of the user along the optimized navigation route. In some examples, the first selectable option may be available for selection to the user while all other options on the user interface are disabled or have a modified appearance to indicate they are not currently selectable or to provide an indication to the user that they are not along the optimized navigation route. The computing platform may send or transmit the generated first user interface to the computing device of the user which may cause the computing device to display the first user interface on a display of the computing device.

At step 308, the computing platform may receive user input selecting the first selectable option from the first user interface. In response, at step 310, the computing platform may generate a second user interface including a second selectable option representing a next step or node along the optimized navigation route. Similar to the first user interface, the second user interface may include the second selectable option and other options may be disabled or have a modified appearance to indicate that are unavailable for selection or are not along the optimized navigation route. The computing platform may transmit or send the second user interface to the computing device which may cause the computing device to display the second user interface.

At step 312, the computing platform 110 may receive user input from the second user interface selecting the second selectable option and, in response, may generate a third user interface at step 314. In some examples, the third user interface may represent a destination node of the user. Alternatively, if additional steps along the navigation route remain, the third user interface may include a selectable option to continue along the optimized navigation route or to process a requested event (e.g., process a transaction). The third user interface may be transmitted or sent to the computing device which may cause the computing device to display the third user interface.

Accordingly, aspects described herein provide for efficient navigation assistance within an application based on a machine-learning generated optimized navigation route and one or more dynamically generated user interfaces. As discussed herein, by providing the dynamically generated user interfaces having the option along the route available for selection and other options unavailable, the user can efficiently navigate through the application to the desired destination (e.g., without returning to a homepage). The arrangements described herein guide the user along the optimized navigation route by providing a series of user interfaces having selectable options identified for the user that will facilitate the user's navigation through the application to the desired destination. By dynamically modifying the CSS and generating the user interface, an optimized navigation route particular to the current user location and, in some examples, current computing resource availability, may be provided.

Although various examples described herein include dynamically generating a user interface to include as available for selection only the option along the optimized navigation route, in some examples, other options (e.g., options along an alternate route) may also be provided as available for selection. In some examples, the alternate route selectable options may have an appearance different from the selectable option along the optimized route and other options not available for selection.

The examples described herein may be provided in the context of, for instance, a mobile or web-based banking application. However, the arrangements described may be used with any application without departing from the invention. For instance, a graph of nodes and edges for a social media application may be generated (e.g., based on customer logs). A user accessing a social media platform via an application may desire to modify settings for the user. The user may select a “help” option, provide a destination or function desired, and the system may generate (e.g., based on the graph of nodes and edges within the social media application) an optimized navigation route through the social media application to the desired destination or function.

Although aspects described herein provide optimized navigation routes having multiple nodes, in some examples, if a user can reach a desired destination via a single step, the system may generate the optimized navigation route and automatically route the user to the destination node (e.g., without generating user interfaces including options for selection).

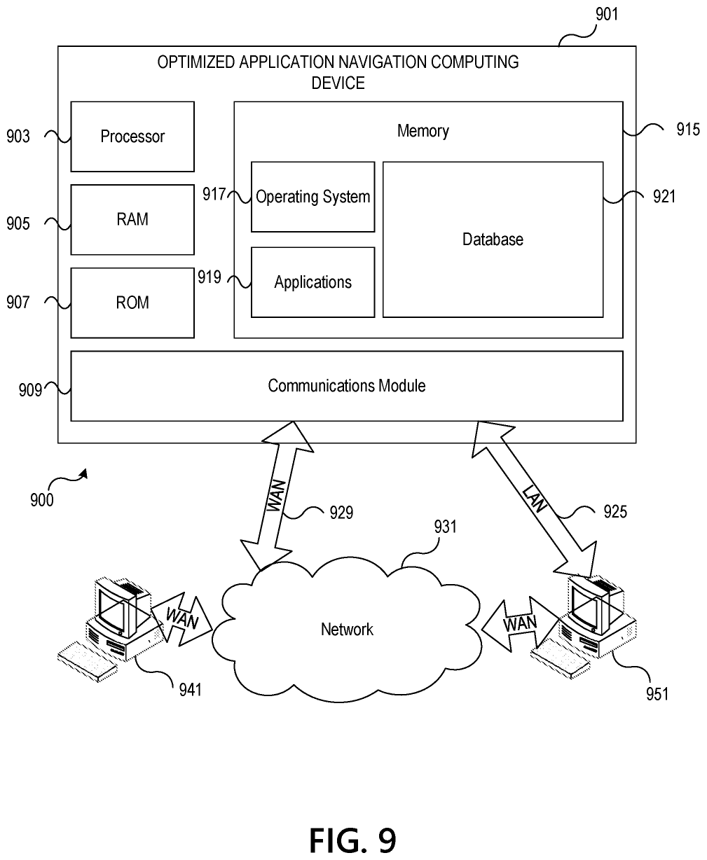

FIG. 9 depicts an illustrative operating environment in which various aspects of the present disclosure may be implemented in accordance with one or more example embodiments. Referring to FIG. 9, computing system environment 900 may be used according to one or more illustrative embodiments. Computing system environment 900 is only one example of a suitable computing environment and is not intended to suggest any limitation as to the scope of use or functionality contained in the disclosure. Computing system environment 900 should not be interpreted as having any dependency or requirement relating to any one or combination of components shown in illustrative computing system environment 900.

Computing system environment 900 may include optimized application navigation computing device 901 having processor 903 for controlling overall operation of optimized application navigation computing device 901 and its associated components, including Random Access Memory (RAM) 905, Read-Only Memory (ROM) 907, communications module 909, and memory 915. Optimized application navigation computing device 901 may include a variety of computer readable media. Computer readable media may be any available media that may be accessed by optimized application navigation computing device 901, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by optimized application navigation computing device 901.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on optimized application navigation computing device 901. Such a processor may execute computer-executable instructions stored on a computer-readable medium.

Software may be stored within memory 915 and/or storage to provide instructions to processor 903 for enabling optimized application navigation computing device 901 to perform various functions as discussed herein. For example, memory 915 may store software used by optimized application navigation computing device 901, such as operating system 917, application programs 919, and associated database 921. Also, some or all of the computer executable instructions for optimized application navigation computing device 901 may be embodied in hardware or firmware. Although not shown, RAM 905 may include one or more applications representing the application data stored in RAM 905 while optimized application navigation computing device 901 is on and corresponding software applications (e.g., software tasks) are running on optimized application navigation computing device 901.

Communications module 909 may include a microphone, keypad, touch screen, and/or stylus through which a user of optimized application navigation computing device 901 may provide input, and may also include one or more of a speaker for providing audio output and a video display device for providing textual, audiovisual and/or graphical output. Computing system environment 900 may also include optical scanners (not shown).

Optimized application navigation computing device 901 may operate in a networked environment supporting connections to one or more other computing devices, such as computing device 941 and 951. Computing devices 941 and 951 may be personal computing devices or servers that include any or all of the elements described above relative to optimized application navigation computing device 901.

The network connections depicted in FIG. 9 may include Local Area Network (LAN) 925 and Wide Area Network (WAN) 929, as well as other networks. When used in a LAN networking environment, optimized application navigation computing device 901 may be connected to LAN 925 through a network interface or adapter in communications module 909. When used in a WAN networking environment, optimized application navigation computing device 901 may include a modem in communications module 909 or other means for establishing communications over WAN 929, such as network 931 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, via an application executing on a computing device of a user, a request for navigation assistance within the application, wherein the request includes a destination within the application;
identify, based on the request, a current node of the user within the application;
execute a machine learning model to identify an optimized navigation route within the application from the current node of the user to a destination node associated with the destination within the application, wherein executing the machine learning model includes using, as inputs to the machine learning model, the current node and the destination node, to output the optimized navigation route;
generate a first user interface including a first selectable option, wherein the first selectable option is associated with a first node along the optimized navigation route;
send, to the computing device, the first user interface including the first selectable option, wherein sending the first user interface causes the computing device to display the first user interface on a display of the computing device;
receive, from the computing device, user selection of the first selectable option;
responsive to receiving the user selection of the first selectable option, generate a second user interface including a second selectable option, wherein the second selectable option is associated with a second node along the optimized navigation route; and
send, to the computing device, the second user interface including the second selectable option, wherein sending the second user interface causes the computing device to display the second user interface on the display of the computing device.

2. The computing platform of claim 1, wherein the second node along the optimized navigation route is the destination node.

3. The computing platform of claim 1, wherein the first selectable option is available for selection and wherein other options on the first user interface are not available for selection.

4. The computing platform of claim 3, wherein the other options are disabled.

5. The computing platform of claim 3, wherein the other options have a modified appearance in the first user interface.

6. The computing platform of claim 1, further including instructions that, when executed, cause the computing platform to:
generate a request for computer resource availability data;
send, to one or more computing systems, the request for computer resource availability data; and
receive, from the one or more computing systems, computer resource availability response data,
wherein executing the machine learning model to identify the optimized navigation route within the application from the current node of the user to the destination node associated with the destination within the application, further includes using, as inputs to the machine learning model, the computer resource availability response data.

7. The computing platform of claim 6, wherein the optimized navigation route is a shortest route from the current node to the destination node.

8. The computing platform of claim 6, wherein the optimized navigation route is a shortest route from the current node to the destination node that avoids computer resources identified as unavailable in the computer resource availability response data.

9. A method, comprising:
receiving, by a computing platform, the computing platform having at least one processor and memory, and via an application executing on a computing device of a user, a request for navigation assistance within the application, wherein the request includes a destination within the application;
identifying, by the at least one processor and based on the request, a current node of the user within the application;
executing, by the at least one processor, a machine learning model to identify an optimized navigation route within the application from the current node of the user to a destination node associated with the destination within the application, wherein executing the machine learning model includes using, as inputs to the machine learning model, the current node and the destination node, to output the optimized navigation route;
generating, by the at least one processor, a first user interface including a first selectable option, wherein the first selectable option is associated with a first node along the optimized navigation route;
sending, by the at least one processor and to the computing device, the first user interface including the first selectable option, wherein sending the first user interface causes the computing device to display the first user interface on a display of the computing device;
receiving, by the at least one processor and from the computing device, user selection of the first selectable option;
responsive to receiving the user selection of the first selectable option, generating, by the at least one processor, a second user interface including a second selectable option, wherein the second selectable option is associated with a second node along the optimized navigation route; and
sending, by the at least one processor and to the computing device, the second user interface including the second selectable option, wherein sending the second user interface causes the computing device to display the second user interface on the display of the computing device.

10. The method of claim 9, wherein the second node along the optimized navigation route is the destination node.

11. The method of claim 9, wherein the first selectable option is available for selection and wherein other options on the first user interface are not available for selection.

12. The method of claim 11, wherein the other options are disabled.

13. The method of claim 11, wherein the other options have a modified appearance in the first user interface.

14. The method of claim 9, further including:
generating, by the at least one processor, a request for computer resource availability data;
sending, by the at least one processor and to one or more computing systems, the request for computer resource availability data; and
receiving, by the at least one processor and from the one or more computing systems, computer resource availability response data,
wherein executing the machine learning model to identify the optimized navigation route within the application from the current node of the user to the destination node associated with the destination within the application, further includes using, as inputs to the machine learning model, the computer resource availability response data.

15. The method of claim 14, wherein the optimized navigation route is a shortest route from the current node to the destination node.

16. The method of claim 14, wherein the optimized navigation route is a shortest route from the current node to the destination node that avoids computer resources identified as unavailable in the computer resource availability response data.

17. One or more non-transitory computer-readable media storing instructions that, when executed by a computing platform comprising at least one processor, memory, and a communication interface, cause the computing platform to:
receive, via an application executing on a computing device of a user, a request for navigation assistance within the application, wherein the request includes a destination within the application;
identify, based on the request, a current node of the user within the application;
execute a machine learning model to identify an optimized navigation route within the application from the current node of the user to a destination node associated with the destination within the application, wherein executing the machine learning model includes using, as inputs to the machine learning model, the current node and the destination node, to output the optimized navigation route;
generate a first user interface including a first selectable option, wherein the first selectable option is associated with a first node along the optimized navigation route;
send, to the computing device, the first user interface including the first selectable option, wherein sending the first user interface causes the computing device to display the first user interface on a display of the computing device;
receive, from the computing device, user selection of the first selectable option;
responsive to receiving the user selection of the first selectable option, generate a second user interface including a second selectable option, wherein the second selectable option is associated with a second node along the optimized navigation route; and
send, to the computing device, the second user interface including the second selectable option, wherein sending the second user interface causes the computing device to display the second user interface on the display of the computing device.

18. The one or more non-transitory computer-readable media of claim 17, wherein the second node along the optimized navigation route is the destination node.

19. The one or more non-transitory computer-readable media of claim 17, wherein the first selectable option is available for selection and wherein other options on the first user interface are not available for selection.

20. The one or more non-transitory computer-readable media of claim 17, further including instructions that, when executed, cause the computing platform to:
generate a request for computer resource availability data;
send, to one or more computing systems, the request for computer resource availability data; and
receive, from the one or more computing systems, computer resource availability response data,
wherein executing the machine learning model to identify the optimized navigation route within the application from the current node of the user to the destination node associated with the destination within the application, further includes using, as inputs to the machine learning model, the computer resource availability response data.
